(19) United States
(12) Patent Application Publication
(10) Pub. No.: US 2026/0063284 A1
(43) Pub. Date: Mar. 5, 2026

(54) MULTIFUNCTIONAL LAMP

(71) Applicant: maglassX GmbH, Hutthurm (DE)

(72) Inventor: Christoph Fritz, Freyung (DE)

(21) Appl. No.: 19/314,112

(22) Filed: Aug. 29, 2025

(30) Foreign Application Priority Data
Aug. 30, 2024 (DE) 102024124940.4

(51) Int. Cl. F21V 21/096; F21V 17/12; F21V 19/02; F21V 23/00

(52) U.S. Cl. CPC F21V 21/096; F21V 17/12; F21V 19/02; F21V 23/003

(57) ABSTRACT

Embodiments of the disclosure include a multifunctional lamp and a elated system. The lamp comprising a lamp stand including a lamp base coupled to an end of a lamp body; and a lamp head coupled to an end of the lamp body opposite the lamp base. The lamp base includes a central magnet adjacent to a bottom. The central magnet is configured to hold the lamp in a stationary condition at a predetermined position, at which a metal element is provided, and in which the metal element interacts with the central magnet.

### BACKGROUND

The present disclosure relates to a multifunctional lamp that is particularly versatile in its use and positioning. The present disclosure also relates to a system comprising the multifunctional lamp and at least one appropriate coaster that interacts with the lamp.

### SUMMARY

The object of the present disclosure is to provide a lamp that can be flexibly and versatilely used and positioned, as well as to provide a system for easy positioning of the lamp that allows a versatile and reversible application of the lamp.

The object is solved by the features of the independent claims.

Embodiments of the disclosure are mentioned in the subclaims and/or the following description.

An aspect of the disclosure provides a multifunctional lamp comprising a lamp body, a lamp base, and a lamp head, wherein by the lamp body and the lamp base a lamp stand for the lamp head is provided, which is arranged opposite to the lamp base at the other end of the lamp body and which is supported by the lamp stand.

The lamp body can thereby in particular be arranged and shaped as a slender, rod-like or stem-like connecting element between the lamp base and the lamp head, and provide a lamp neck of the lamp.

The lamp base includes a central magnet adjacent to its base, which is selected and arranged regarding its magnetic properties, in particular its holding force or magnetic attraction force and its dimensions, in accordance with the lamp such that the lamp is held by the magnet in a slip-resistant, stable, and stationary condition at a predetermined position, at which an appropriate metal element or an appropriate metal layer is provided, which interacts with the magnet.

By the magnet arranged adjacent to the bottom of the lamp base, a multifunctional lamp is provided which can be used in many applications in a simple, flexible, versatile manner and, in particular, in a stationary, slip-resistant and stable condition.

In case of a flat-cylindrical lamp base, the magnet can appropriately also be shaped as a flat cylinder with a diameter that is slightly larger than half the diameter of the lamp base, wherein the magnet can be provided by means of a neodymium magnet. Thus the magnet can be selected and arranged in its magnetic properties, in particular its holding force or its magnetic attraction force and its dimensions, corresponding with the lamp and in particular with the lamp base, such that the lamp is held slip-resistant, stable and stationary by the magnet at a predetermined position, at which an appropriate metal element or an appropriate metal layer is provided, which interacts with the magnet.

In this connection, the magnet can be selected and arranged corresponding with the lamp and in particular also with the lamp base such that the predetermined position can also be on a vertical wall or on a ceiling, so that the lamp is held in place with its lamp base attached to the vertical wall or ceiling, whereby the lamp body extends horizontally or vertically downwards from the lamp base. As a consequence the application and use of the multifunctional lamp as a floor lamp but also as a wall lamp and even as a ceiling lamp is particularly versatile.

The magnet can thereby be appropriately arranged and dimensioned such that the lamp placed on the lamp base, when used as for example a floor lamp, rests substantially on an appropriate support pad provided on the lamp base, while the centrally arranged magnet is spaced at a predetermined very short distance from a surface on which the lamp base is placed.

This also applies to the advantageous alternative use of the multifunctional lamp as a wall lamp or ceiling lamp, whereby the support pad is in contact with the surface of a wall. The magnet here also has a predetermined, very small distance to the surface of the wall at the predetermined position where the lamp base is attached to the wall, and is held there securely, slip-resistant and stationary by the magnet. It is clear that here the surface of the wall comprises an appropriate metal element or an appropriate metal layer that interacts with the magnet.

As described above, the lamp base can be appropriately shaped, in particular, as a flat cylinder and open at the bottom, wherein a first iron plate, a second iron plate, and the magnet are arranged in the lamp base and fixed in the lamp base whereby the magnet is screwed to the first iron plate below the first iron plate and is thereby positively arranged in a central recess of the second iron plate. Thus, the magnet is shielded by the first iron plate in the direction of the lamp head, in which, as described below, appropriate electronics for a multifunctional lighting operation of the lamp can be provided.

For screwing the magnet to the first iron plate, the magnet comprises two through-holes, which are appropriately arranged diametrically opposite one another adjacent to the edge of the magnet, wherein each hole is provided for a screw for fixing the magnet to the first iron plate in the lamp base, respectively. To protect the magnet and the interior of the lamp base from moisture and contamination, the exposed underside of the magnet, which is positively arranged in the lamp base in the central recess of the second iron plate and screwed to the first iron plate, can be suitably covered and protected with a thin protective film made of metal and/or plastic, whereby the protective film can be appropriately glued to the underside of the magnet.

In addition the magnet can be appropriately arranged in a central recess of the support pad provided on the lamp base, which, as described above, is in contact with the surface onto which the lamp base is placed or attached. The support pad is configured such that it surrounds the magnet in a ring shaped arrangement, whereby the support pad is appropriately attached to the second iron plate. For example, the support pad can be glued to the lower second iron plate.

The second iron plate, the magnet, and the support pad hereby each have a predetermined thickness, which is selected such that the lamp placed on the assembled lamp base rests substantially on the support pad, while the centrally arranged magnet is only spaced at a predetermined small distance from the surface on which the lamp base is placed. Due to the dimensions and arrangement of the iron plates and the magnet, as well as the support pad, the magnet is held at a small distance from a smooth support surface.

The above predetermined small distance is suitably in the range of max. 2 mm and advantageously max. 1 mm. This spacing is particularly advantageous both for protecting the magnet and a surface, particularly against scratching, and for advantageous slip prevention in interaction with the support pad that surrounds the magnet in a ring shaped arrangement and a coaster described below. Furthermore, the predetermined, advantageous, very small distance also ensures that the holding force or magnetic attraction force of the magnet is not impaired in its interaction with a metal layer or a metal element.

For this purpose, the above mentioned support pad provided on the lamp base can be configured to be slip-resistant by means of a circular support pad made of silicone and can thereby comprise a central recess and which can consequently be arranged on the lamp base such that the support pad surrounds the magnet in a ring shaped arrangement.

The first upper iron plate can shaped as a flat circular disk corresponding to the diameter of the suitably cylindrical lamp base and can comprise a recess which, starting from the center of the iron plate, extends radially to its edge up to a recess in the side wall of the lamp base, in which recess a charging port is arranged for charging a battery provided in the lamp head for electrically operating the lamp by means of suitable electronics. The rechargeable battery enables advantageously flexible and versatile application of the multifunctional lamp independent of a power source at any position, even at a distance from any power source. The charging port can suitably be a USB Type-C port provided for an appropriate cable that is connected to an appropriate charging device.

As mentioned above, an electronic device comprising suitable control electronics, an LED board and a reflector can be provided in the lamp head, which interacts with the battery and which is configured such that the lamp in particular has a DIM function and a function for adjusting the color temperature of the lamp. The multifunctional lamp can therefore not only be used in a variety of flexible ways at any suitable predetermined position as a floor lamp, wall lamp or even as a ceiling lamp. The lighting can also be advantageously adjusted in a variety of ways by using the multifunctional lamp adapted to its position and application. It is clear that for this purpose, a suitable control panel for adjusting the lighting is provided, in particular on the lamp head, which interacts with the electronics in the lamp head described above.

For in particular flexible application of the multifunctional lamp as a floor lamp and/or as a wall lamp and/or as a ceiling lamp, the lamp head can be arranged pivotable on the lamp body, particularly by 180°, so that the illumination can be continuously adjusted from a direction directed towards the lamp base up to an opposite direction. For this purpose, the lamp head can comprise a recess in which the end of the lamp body connected to the lamp head is connected to the lamp head via an appropriate joint, whereby the lamp body or the lamp neck is rod-like.

The lamp head described above may suitably have a predetermined cylindrical, and in particular an applicable conical shape and comprise a lower translucent cover through which the illumination is provided. The lamp head and the suitably flat, cylindrical lamp base may suitably be made of aluminum. It is clear that the lamp head may, of course, also have a different shape, such as a spherical shape.

The recess described above of the pivotable embodiment of the lamp head can appropriately be adapted to extend in a slot-like manner to a central axis of the lamp head, such that the lamp body is a slender lamp neck, enters the center of the lamp head at a pivot angle of 0°, as with a non-pivotable lamp. Thus the lamp head, pivotable by an angle of 0° to 180°, advantageously always remains in the center of the support surface, such that the occurrence of possible tilting moments, including for the lamp head itself, is advantageously minimized. An appropriate self-locking mechanism of the joint for holding the lamp head in a predetermined pivoted position is thus advantageously less required, and the joint is moreover advantageously protected from contamination.

An above described multifunctional lamp can be particularly advantageous for use at home and/or in the garden and/or while camping, and especially advantageous for use on a means of transport and/or in a vehicle, particularly since, in interaction with a metallic base, it enables flexible, simple, secure, stable, and slip-resistant handling of the multifunctional lamp. Moreover the flexible use of the multifunctional lamp can obviously be advantageous, for example, in offices or restaurants.

For using an above multifunctional lamp equipped with a magnet, the lamp can interact with an appropriate metallic base as described above, and thus, particularly advantageously interact with an appropriate coaster comprising a metal layer that interacts with the magnet of the lamp, whereby the coaster is may be provided by a nano-gel adhesive pad comprising a slip-resistant, adhesive underside. A corresponding coaster is particularly advantageous, since the coaster is adapted for retrofitting of a surface, such as a tray, table, shelf, wall, etc., and enables a simple and advantageous, and in particular flexible and reversible, as well as secure and stationary, positioning of the multifunctional lamp.

The disclosure therefore also relates to a system comprising a multifunctional lamp as described above and at least one coaster corresponding to the lamp and the magnet, whereby the coaster comprises a metal layer that interacts with the magnet and whereby the coaster is provided by a nano-gel adhesive pad comprising a slip-resistant, adhesive underside such that the coaster adheres to a predetermined position in a slip-resistant and adherent condition, and thereby interacts with the support pad provided on the lamp base and in particular with the magnet, such that the lamp with the lamp base adheres to the coaster in a stationary, stable and slip-resistant condition.

The system can advantageously comprise a plurality of above mentioned coasters, which are provided for slip-resistant positioning of the multifunctional lamp at least one or a plurality of positions, whereby the coasters can also be designed differently, particularly regarding their dimensions. Coasters that adhere particularly well to a surface, such as a vertical wall or a ceiling, can cover a larger area than the base of the lamp base and have correspondingly appropriate dimensions. Thus a corresponding system is adapted for particularly simple and flexible handling of the multifunctional lamp described above for many applications.

### BRIEF DESCRIPTION OF THE DRAWINGS

Embodiments of the disclosure are illustrated in the figures and explained in more detail below. In this regard show:

FIG. 1 an exploded view of a multifunctional lamp according to an embodiment of the disclosure;

FIG. 2 the lamp of FIG. 1 assembled in an enlarged perspective view, according to embodiments of the disclosure;

FIG. 3A a lamp according to the disclosure, from an other perspective;

FIG. 3B a side view of a lamp according to the disclosure, adjacent to a wall;

FIG. 4 a perspective view of a multifunctional lamp according to an embodiment of the disclosure;

FIG. 5 a lamp according to the disclosure, positioned on a wall;

FIG. 6 a lamp according to the disclosure, with a coaster appropriate for positioning the lamp;

FIG. 7A a lamp according to the disclosure, with a charging cable and a charging device;

FIG. 7B a schematic representation of an selected lighting function of a multifunctional lamp according to embodiments of the disclosure.

The figures may comprise partly simplified, schematic illustrations. To some extent, identical designations are used for elements which are the same but possibly not identical. Different views of the same elements could be scaled differently. Not all reference symbols are shown in all figures.

### DETAILED DESCRIPTION

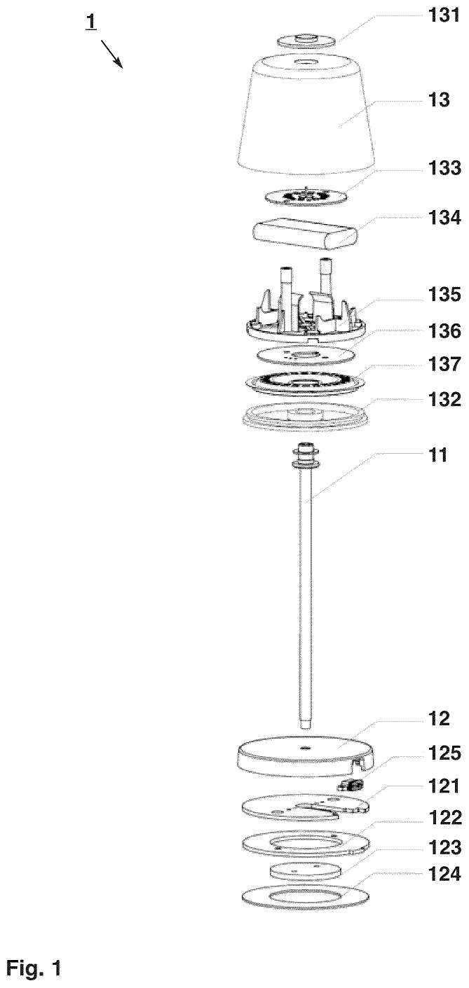

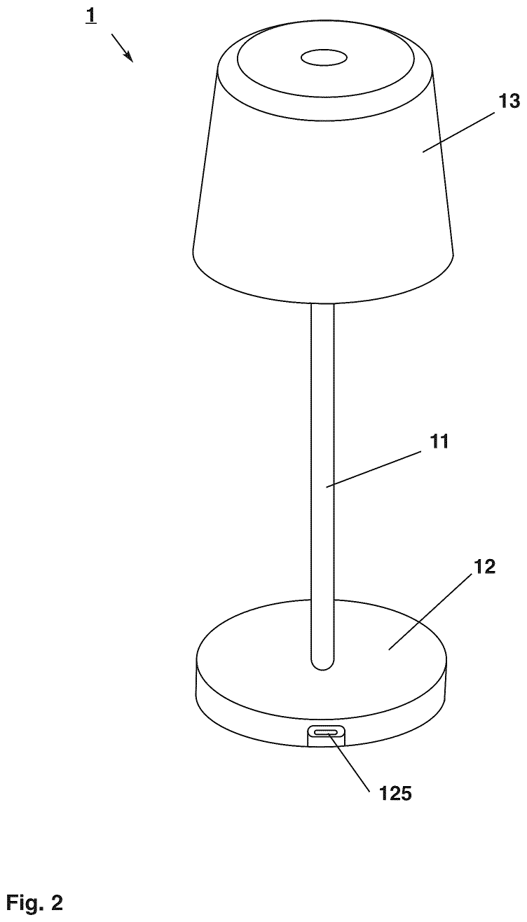

FIG. 1A shows a multifunctional lamp 1 according to an embodiment of the disclosure in a schematic exploded view of the lamp body 11, the lamp base 12 or lamp socket 12 and the lamp head 13. The assembled multifunctional lamp 1 is shown in an enlarged perspective view of FIG. 2. The rod-like, slender lamp body 11, together with the lamp base 12, provides a lamp stand 11, 12 for the lamp head 13, which is arranged opposite to the lamp base 12 at the other end of the lamp body 11 and is supported by the lamp stand 11, 12. The lamp body 11 is thereby arranged as a rod-like, stem-like connecting element between the lamp base 12 and the lamp head 13 and provides a slender lamp neck 11 of the lamp 1.

A first iron plate 121, a second iron plate 122, and a magnet 123 are arranged and fixed in the flat-cylindrical, downwardly open aluminum lamp base 12. The first upper iron plate 121 is as a flat, circular disk corresponding to the diameter of the cylindrical lamp base 12, and the first upper iron plate 121 comprises a recess extending radially from the center of the iron plate 121 to its edge up to a recess in the side wall of the lamp base 12, where a charging port 125 is arranged in the lamp base 12 for charging a rechargeable battery 134 provided in the lamp head 13 for electrically operating the lamp 1.

As the diameter of the first iron plate 121, the diameter of the second iron plate 122 arranged below the first iron plate 122 corresponds also with the diameter of the lamp base 12. Contrary to the first iron plate 121, the second iron plate 122 comprises a central recess, which is configured for receiving and accommodating of the as well flat cylindrical magnet 123 and corresponds accordingly with its dimension. The diameter of the magnet 123 is slightly larger than half the diameter of the lamp base 12. The magnet 123 comprises two through-holes which are intended for screws for fixing the magnet 123 in the lamp base 12. A circular support pad 124 made of silicone which also comprises a central recess is formed to be slip-resistant and surrounds the magnet 123 in a ring shape.

For providing a stable and secure attachment of the magnet 123 in the lamp base 12, the cylindrical magnet 123 comprises the above mentioned two through-holes, which are appropriately arranged diametrically opposite one another adjacent to the edge of the magnet, and which are each provided for a screw for fixing the magnet 123 to the first iron plate 121 in the lamp base 12, respectively, whereby the screws are not shown in the figure for the protection of particularly also the interior of the lamp base 12 from moisture and contamination, the exposed underside of the magnet 123, which is positively arranged in the lamp base 12 in the central recess of the second iron plate 122 and screwed to the first iron plate 121, can be appropriately covered and protected with a thin protective film made of metal and/or plastic. The protective film which is not shown in the figure can thereby be suitably glued to the underside of the magnet 123.

The first iron plate 121, the second iron plate 122, the magnet 123, and the support pad 124 are assembled and mounted in the lamp base 12, such that the magnet 123 is screwed to the first iron plate 121 below the first iron plate 121, whereby the magnet 123 is positively arranged in the central recess of the second iron plate 122. The magnet 123 is thereby also arranged in the central recess of the support pad 124, which surrounds the magnet 123 in a ring shape and which is attached to the second iron plate 122. For example, the support pad 124 can thereby be glued to the second iron plate 122. The second iron plate 122, the magnet 123 and the support pad 124 each have a thickness selected such that the lamp 1 placed on the assembled lamp base 12 rests substantially on the support pad 124, while the centrally arranged magnet 123 is spaced at a very short distance from a surface on which the lamp base 12 is placed.

As described above, the predetermined small distance is suitably in the range of max. 2 mm and advantageously max. 1 mm. This spacing is particularly advantageous both for protecting the magnet 123 and also a surface from scratching and for advantageous slip prevention in interaction with the support pad 124, which surrounds the magnet 123 in a ring shape, and also with a coaster 2 described below. Furthermore, by the predetermined advantageous very small distance, the holding force or the magnetic attraction force of the magnet 123 is not impaired in its interaction with a metal layer M or a metal element M.

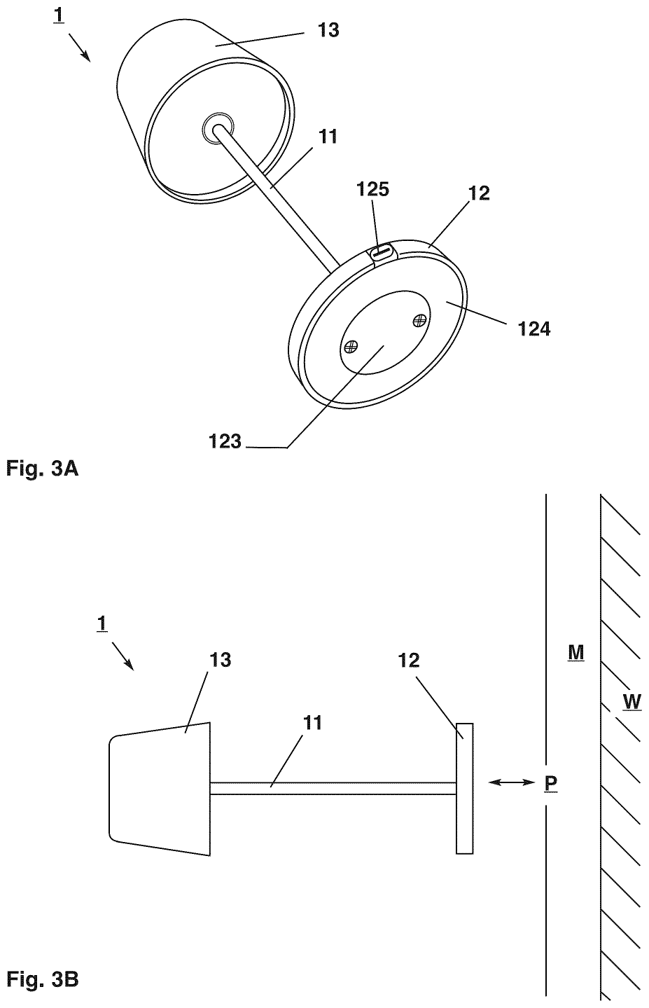

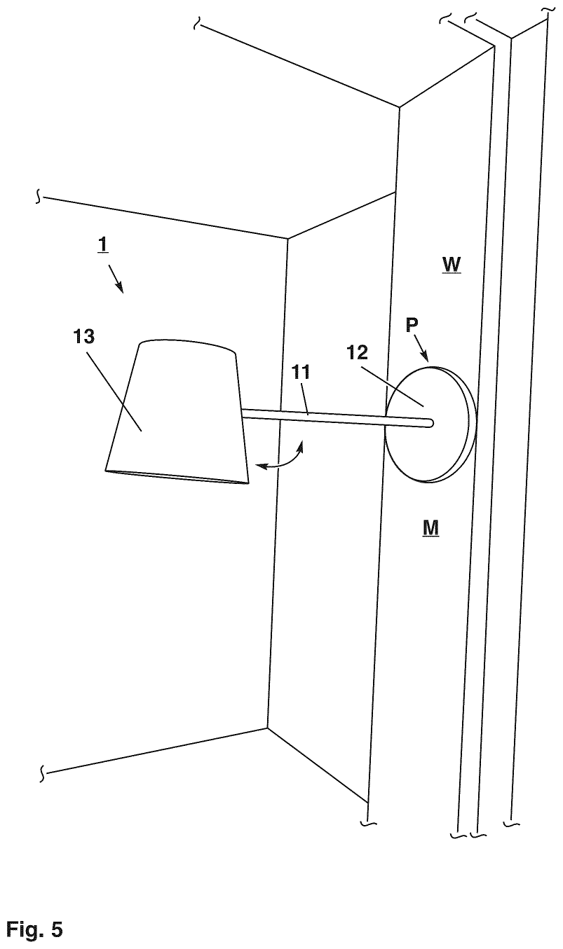

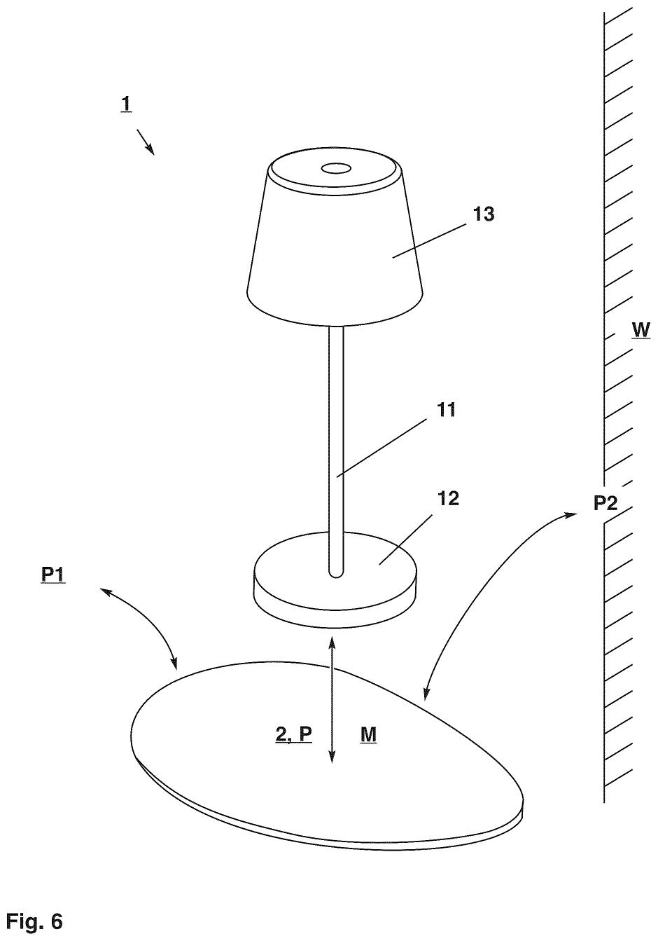

The magnet 123 is advantageously provided by a neodymium magnet, and its magnetization is selected such that the multifunctional lamp 1 can be positioned, used, or operated in a variety of ways at any position that comprises a metallic support that interacts with the magnet 123. In particular, the multifunctional lamp 1 can thereby be used in interaction with a suitable coaster 2, described below with reference to FIG. 6. For the advantageous possible applications and, in particular, in positioning of the multifunctional lamp 1 comprising the magnet 123, reference is made here to the following description of FIG. 3A, FIG. 3B, FIG. 5, and FIG. 6.

As described above, the magnet 123 is arranged in the assembled lamp base 12 directly below the first iron plate 121 and is screwed to the first iron plate 121, whereby the first iron plate 121 shields the magnetic field of the magnet 123 and thereby provides a corresponding protection for the electronics arranged in the lamp head 13 described below.

The lamp head 13, which is attached to the lamp body 11 opposite to the lamp base 12, is slightly conical and, as the lamp base 12, the lamp head 13 is also made of aluminum. The lamp head 13 thereby comprises a first upper cover 131 and a second lower cover 132, each of which can be suitably translucent. A central control panel for operating the lamp 1 is provided on the upper cover. The control electronics 133, arranged on a holder 135 in the lamp head 13, interacts with the central control panel. A rechargeable battery 134 for power supply of the lamp 1 is also arranged on the holder 135. For this purpose, appropriate electrical lines, which are not shown in FIG. 1, extend from the charging port 125 through the lamp base 12 and the lamp body 11.

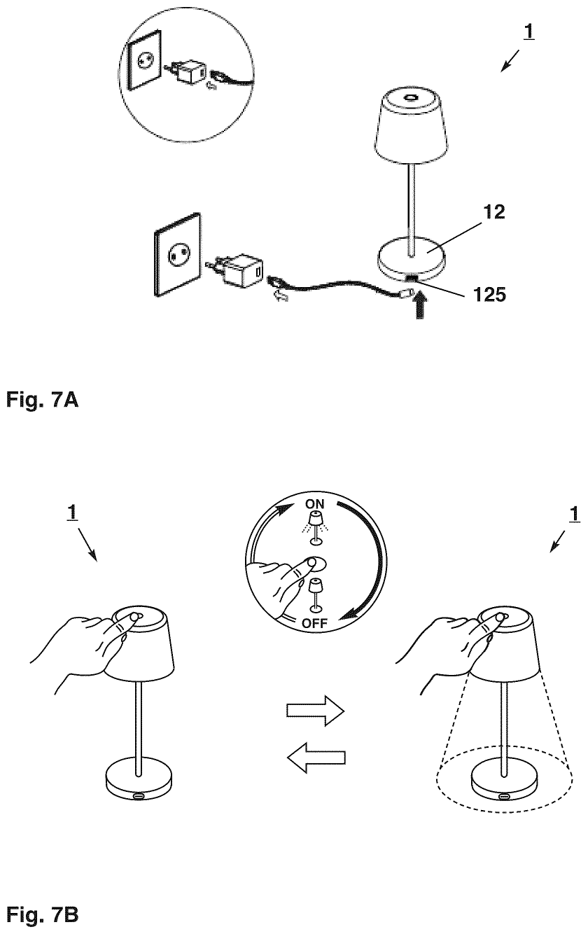

With the advantageous power supply via the rechargeable battery, the multifunctional lamp 1 can advantageously be used in a variety of ways at any position, even at a distance from any power source. An LED board 136 and a reflector 137 are arranged in the lamp head 13 below the holder 135. The electronics for operating the multifunctional lamp 1, in particular the control electronics 133, the LED board 136, the reflector 137, and the translucent lower cover 132, can be easily and versatilely adjusted by using the control panel provided on the upper cover 131, thus providing not only multifunctional use of versatile, flexible positioning but also multifunctional lighting operation of the lamp 1, which is described by way of example below with reference to FIG. 7B.

FIG. 3A shows the multifunctional lamp 1 of FIG. 1 and FIG. 2 from another perspective, and FIG. 3B shows a side view of the lamp 1 adjacent to a wall W.

The central magnet 123 is, as described above, fixed to the lamp base 12 by means of screws and is in a ring surrounded by the support pad 124, whereby the cylindrical magnet 123 has a diameter that is slightly larger than half the diameter of the lamp base 12. As also described above, the magnet 123 and the support pad 124 are thereby arranged such that substantially the support pad 124 of the lamp base 12 comes into contact with a surface on which the lamp 1 with its lamp base 12 is placed or positioned, whereby the centrally arranged magnet 123, as described above, is spaced from the surface only by a predetermined small distance.

As described in the summarizing portion and above with reference to FIG. 1, the magnet 123 comprises two diametrically opposed, through-holes adjacent to its edge, wherein the two through-holes are provided for screws for fixing the magnet 123 by screwing it to the first iron plate 121 in the lamp base 12. To protect the magnet 123 and the interior of the lamp base 12 from moisture and contamination, the exposed underside of the magnet 123 can be appropriately covered and protected with a thin protective film made of metal and/or plastic. The thin protective film is not shown in the figure and can be glued to the underside of the magnet 123.

The surface on which the lamp base 12 is placed or to which the lamp base 12 is attached can, due to the advantageous magnet 123, not only be a flat horizontal surface but also an inclined surface and in particular also a metallic surface comprising a metal layer or metal layer M of a vertical wall W, to which the multifunctional lamp 1 can advantageously be reversibly positioned and attached by means of the magnet 123. In this connection FIG. 3B shows the multifunctional lamp 1 with its lamp base 12 adjacent to a predetermined position P on a wall W comprising a metal layer M, whereby when completely attached to the wall W the lamp base 12 is fastened to the wall W by means of the magnet 123, and whereby the lamp body 11 attached at the position P extends substantially horizontally from the lamp base 12.

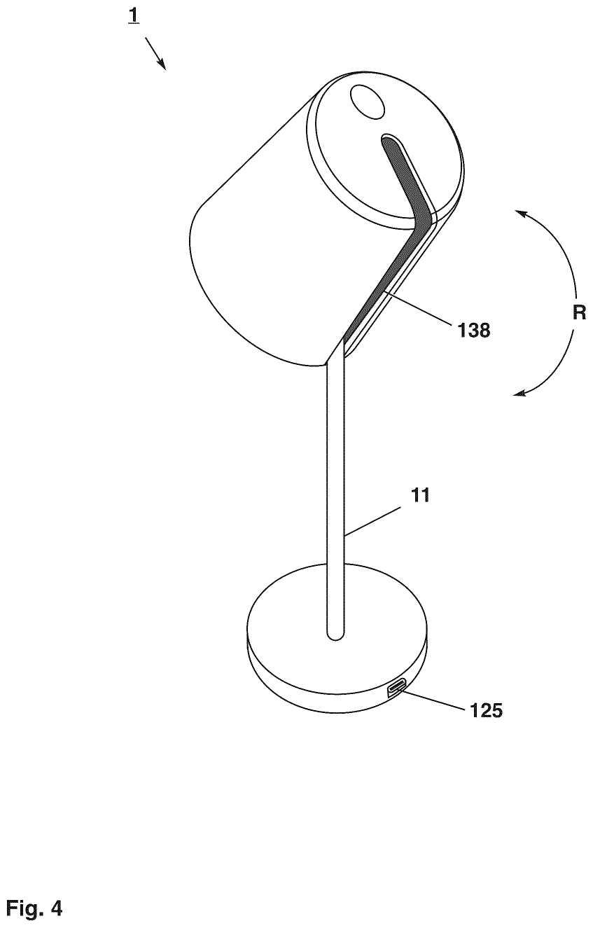

FIG. 4 shows a perspective view of a multifunctional lamp 1 according to an embodiment of the disclosure, which substantially corresponds to the embodiment of FIG. 1 and FIG. 2, whereby in this regard reference is made here to the above description. Different to the embodiment of FIG. 1 and FIG. 2, the lamp head 13 of the embodiment of FIG. 4 is configured to be pivotable appropriately by 180° in a direction R such that the lamp head 13 with its lower translucent cover 132 can be continuously pivoted from a position at which the cover 132 is directed to the lamp base 12 to a position at which the cover 132 is completely directed away from the lamp base 12. For this purpose, the lamp head 13 comprises a suitable recess 138 in which the lamp body 11 engages the lamp head 13, which is attached to the lamp body 11 by means of a suitable joint.

In this connection FIG. 5 shows the lamp 1 of FIG. 4 positioned and attached on a wall W comprising a suitable metal layer M interacting with the magnet 123. The position P and the wall W are, for example, provided by a door frame made of metal M. The lamp base 12 is attached to the wall W by means of the magnet 123, whereby the lamp body 11 extends from the lamp base 12 substantially horizontally, and whereby the lamp head 13 is pivoted by, for example approximately 90°, such that the lower translucent cover 132 of the lamp head 13 is directed downwards towards to the floor.

The recess 138 of the lamp head 13 can be adapted to extend in a slot-like manner up to a central axis of the lamp head 13, so that the lamp body 11, which is shaped as a slender lamp neck, enters the center of the lamp head 13 at a pivot angle of 0°, as into a non-pivotable lamp. Thus, the lamp head 13, pivoted by an angle of 0° to 180°, always remains in the center of the support surface, such that the occurrence of possible tilting moments, including for the lamp head 13 itself, is advantageously minimized. As a consequence a requirement of an appropriate self-locking mechanism of the joint for holding the lamp head 13 in a predetermined pivoted position is thus advantageously reduced, and the joint is moreover advantageously protected from contamination.

FIG. 6 shows the multifunctional lamp 1 of FIGS. 1 and 2 together with a coaster 3 appropriate for positioning the lamp 1.

The flat coaster 2 is suitably provided by a nano-gel adhesive pad comprising a slip-resistant and adhesive underside, and a metal layer that interacts with the magnet 123 of the lamp base 12. The coaster 2 comprising its slip-resistant and adhesive underside, is thereby adapted for easy and flexible placement or attachment at a predetermined position P, P1, P2 on a surface, e.g., a piece of furniture, such as a table, a shelf, or a rack, or even a wall W, such that the coaster 2 can be positioned in a slip-resistant and adherent condition, as well as reversibly, for use with the multifunctional lamp 1. Thus the coaster 2 of FIG. 6 shows a larger surface and adhesive area compared to the bottom of the lamp base 12, such that the coaster 2 adheres particularly well, especially to vertically extending walls W.

Thus the lamp base 12, with its slip-resistant silicone support pad 124 and in particular with its magnet 123, interacts with the coaster 2 comprising a metal layer configured such that the multifunctional lamp 1 is held stable and slip-resistant on the coaster 2.

The coaster 2, which interacts with the magnet 123 of the lamp base 12, is thereby arranged with its underside in a slip-resistant adherent condition at a predetermined position P, P1 or P2. In addition to the above mentioned coaster 2 at position P, in FIG. 6 two further positions P1 and P2 are schematically shown. As already mentioned above, the positions P, P1 and P2 can each represent a predetermined position P, P1, P2 on a surface for example of a piece of furniture, such as a table or shelf or a storage area, for example also in a vehicle and, particularly, also on a wall W.

Thus a system 1, 2 for slip-resistant positioning of the multifunctional lamp 1 at at least one predetermined position P, P1, P2 is provided, comprising a multifunctional lamp 1, the lamp base 12 of which being equipped with a central magnet 123, and at least one coaster 2 that interacts with the lamp base 12, whereby the coaster 2 comprises a metal layer M that interacts with the magnet 123, and whereby the coaster 2 is provided by a nano-gel adhesive pad comprising a slip-resistant and adhesive base. The system 1, 2 can comprise a plurality of coasters 2, which are provided for slip-resistant positioning at a plurality of positions P, P1, P2, respectively.

FIG. 7A shows a reduced representation of the multifunctional lamp 1 of FIG. 1 and FIG. 2 together with a charging cable and a charger for the above-described advantageous charging of the battery 134. Thus, the lamp 1, with the battery 134 charged, can be easily and flexibly positioned, used, and operated at any predetermined position P, even at a distance from any power source. The charging port 125 described above is suitably a USB Type-C port.

In addition FIG. 7B shows a schematic representation of a selected function of the multifunctional lamp 1 by manually operating the central touch-sensitive control panel in the upper cover 131, according to which, in particular, a dimming function can be continuously adjusted using the electronics described above. Furthermore, a color temperature of the multifunctional lamp 1 can also be adjusted using the control panel and the electronics described above.

Although various aspects or features of the disclosure are shown in combination in the figures, it will be apparent to those skilled in the art-unless otherwise stated—that the illustrated and discussed combinations are not the only possible ones. In particular, corresponding units or feature combinations from different embodiments can be interchanged.

What is claimed is:

1. A lamp comprising:
a lamp stand including a lamp base coupled to an end of a lamp body; and
a lamp head coupled to an end of the lamp body opposite the lamp base,
wherein the lamp base includes a central magnet adjacent to a bottom, and wherein the central magnet is configured to hold the lamp in a stationary condition at a predetermined position, at which a metal element is provided, and in which the metal element interacts with the central magnet.

2. The lamp according to claim 1, wherein the central magnet is arranged and configured such that the lamp rests on a support pad provided on the lamp base, while the central magnet is spaced a distance from a surface on which the lamp base is placed.

3. The lamp according to claim 1, wherein:
the lamp base is flat-cylindrical and open at the bottom, and includes a first iron plate, a second iron plate, wherein the central magnet is arranged and attached therein,
the first iron plate, the second iron plate and the central magnet are coupled to the lamp base via the central magnet being screwed to the first iron plate below the first iron plate and is thereby positively arranged in a central recess of the second iron plate, and
the support pad is coupled to the second iron plate, and the support pad includes a central recess that surrounds the central magnet in a ring shaped arrangement.

4. The lamp according to claim 3, wherein:
the central magnet is flat-cylindrical, and includes two through-holes adjacent an edge of the central magnet and arranged on diametrically opposite sides,
the through-holes are provided for screws to fix the central magnet to the first iron plate in the lamp base, respectively, and
an underside of the central magnet is covered by a thin protective film made of at least one of metal or plastic.

5. The lamp according to claim 3, wherein the central magnet is spaced between approximately 1-2 millimeters (mm) from the surface on which the lamp base is placed.

6. The lamp according to claim 3, wherein the first iron plate is a flat circular disc corresponding to the diameter of the lamp base, having a cylindrical cross-section, and includes a recess extending radially from a center of the first iron plate to an edge up to a recess in a side wall of the lamp base, in which a charging port is arranged for charging a battery provided in the lamp head for electrically operating the lamp.

7. The lamp according to claim 6, further comprising an electronic device including a control electronics, an LED board, and a reflector, provided in the lamp head, wherein the electronic device is configured to interact with the battery, and includes a dimming function and a function for adjusting the color temperature of the lamp.

8. The lamp according to claim 2, wherein the support pad (124) is circular and includes a silicone material.

9. The lamp according to claim 1, wherein the lamp head is configured to pivot at least 180°.

10. The lamp according to claim 9, wherein:
the lamp head is at least one of cylindrical or conical, and
the lamp body includes a lamp neck, and
the lamp head includes a recess in which the lamp neck engages the lamp head, via a joint, and wherein the recess extends in a slot-like manner to a central axis of the lamp head, so that the lamp neck enters the lamp head centrally at a pivot angle of 0°.

11. The lamp according to claim 1, wherein:
the central magnet is a flat cylinder with a diameter larger than a diameter of the lamp base,
the central magnet is a neodymium magnet; and
the central magnet is configured to hold the lamp in a stationary condition at the predetermined position including at least one of a vertical wall (W) or a ceiling.

12. A system comprising a lamp according to claim 2, and
at least one coaster corresponding to the lamp and the central magnet therein, wherein:
the at least one coaster includes a metal layer that interacts with the central magnet and whereby the at least one coaster is a nano-gel adhesive pad with an adhesive underside, such that the at least one coaster adheres to the predetermined position, and
the at least one coaster interacts with the central magnet such that the lamp with the lamp base adheres to the coaster.
